(19) United States
(12) Patent Application Publication
(10) Pub. No.: US 2023/0267167 A1
(43) Pub. Date: Aug. 24, 2023

(54) TWO-DIMENSIONAL DATA CONVERSION DEVICE, METHOD, AND PROGRAM

(71) Applicant: Nippon Telegraph and Telephone Corporation, Tokyo (JP)

(72) Inventors: Masahiro Ueno, Tokyo (JP); Yurina Tanaka, Tokyo (JP); Sohan Kawamura, Tokyo (JP); Takashi Sakamoto, Tokyo (JP); Yuichi Akage, Tokyo (JP); Soichi Oka, Tokyo (JP)

(21) Appl. No.: 18/004,274

(22) PCT Filed: Jul. 15, 2020
(86) PCT No.: PCT/JP2020/027469

§ 371 Date: Jan. 4, 2023

(51) Int. Cl. G06F 17/14; G06F 17/16

(52) U.S. Cl. CPC G06F 17/14; G06F 17/16

(57) ABSTRACT

A column reader, a one-dimensional transformer, and a row writer repeat reading of one or more columns, one-dimensional transform of one or more columns, and writing of one or more rows until all original data of M rows and N columns is transformed and recorded in an auxiliary storage device as intermediate data of N rows and M columns. A column reader, a one-dimensional transformer, and a row writer repeat reading of one or more columns, one-dimensional transform of one or more columns, and writing of one or more rows until all of the intermediate data is transformed and recorded in the auxiliary storage device as final data of M rows and N columns.

### CROSS-REFERENCE TO RELATED APPLICATIONS

This patent application is a national phase filing under section 371 of PCT application no. PCT/JP2020/027469, filed on Jul. 15, 2020, which application is incorporated herein by reference in its entirety.

### TECHNICAL FIELD

The present invention relates to a two-dimensional data transform device, a two-dimensional data transform method, and a program for performing two-dimensional transform such as two-dimensional Fourier transform or two-dimensional Hadamard transform at a high speed by using an auxiliary storage device.

### BACKGROUND

In two-dimensional transform such as two-dimensional Hadamard transform or two-dimensional Fourier transform, a base function can be separated into two variables in a horizontal direction and a vertical direction. When the horizontal direction is a row direction and the vertical direction is a column direction, such two-dimensional transform may be performed by first performing row direction one-dimensional transform on each of all rows and then performing one-dimensional transform in the column direction on each of all columns. Alternatively, even if the order of one-dimensional transform is reversed, with column direction one-dimensional transform being performed first on each of all columns and then row direction one-dimensional transform being performed on each of all columns, two-dimensional transform may be similarly performed.

Non Patent Literature 1 discloses a specific transform method of performing two-dimensional Hadamard transform, two-dimensional Fourier transform, or the like by using an auxiliary storage device.

In a first transform method, one-dimensional transform is performed on all rows of two-dimensional data D1 to output data D2, the data D2 is transposed to output data D3, one-dimensional transform is performed on all rows of data D3 to output data D4, and the data D4 is further transposed to output data D5.

The one-dimensional transform process and the transposition process are performed in a main storage device, and reading of data before these processes and writing of data after the processes are performed for an auxiliary storage device. That is, the data D1, D2, D3, D4, and D5 are recorded in the auxiliary storage device. When the one-dimensional transform process and the transposition process are performed, data is read from the auxiliary storage device to the main storage device before the processes, and data is written from the main storage device into the auxiliary storage device after the processes.

In a case where a size of the two-dimensional data D1 is M rows and N columns, each of reading and writing of a row for the first row direction one-dimensional transform is performed M times. The number of elements (elements of data) in each row is N.

Each of reading of the column and writing of the row for the first transposition is performed N times. Each of the number of elements in each column at the time of reading and the number of elements in each row at the time of writing is M.

Reading and writing of a row for the second row direction one-dimensional transform are performed N times. The number of elements in each row is M.

Each of reading of the column and writing of the row for the second transposition is performed M times. Each of the number of elements in each column at the time of reading and the number of elements in each row at the time of writing is N. The total numbers of times in which reading and writing are performed in the auxiliary storage device are as shown in Table 1.

TABLE 1

| Read | | | | Write | |
|---|---|---|---|---|---|
| Row | | Column | | Row | |
| Number of | Number of | Number of | Number of | Number of | Number of |
| elements | times | elements | times | elements | times |
| N | M | N | M | N | 2M |
| M | N | M | N | M | 2N |

Non Patent Literature 1 also discloses a second transform method. This transform method is devised such that access of each column is eliminated from the auxiliary storage device, and two-dimensional transform can be executed only by access of each row. In order to describe this deviser, first, fast one-dimensional transform such as fast one-dimensional Hadamard transform or fast one-dimensional Fourier transform will be described.

In a basic processing method of fast one-dimensional transform, when the number of elements is N=Sⁿ (where S and n are each an integer of 2 or greater), first, N pieces of data are divided into N/S sets in which one set is S according to a certain rule, and one-dimensional transform is performed on all the sets. Next, all the N elements after the primary transform are divided into N/S sets in which one set is S according to a certain rule, and one-dimensional transform is performed on each of all the sets. Data after such one-dimensional transform is repeated n times is final data.

Each of the n times will be referred to as a stage. A calculation amount in each stage is N order. Since there are n (=logₛN) stages as a whole, a calculation amount of fast one-dimensional transform is N×n (=NlogₛN), and thus it is possible to suppress a calculation amount to be lower than the calculation amount of the N² order in a case where speeding up is not considered.

Next, the second transform method disclosed in Non Patent Literature 1 will be described. In the second transform method, one-dimensional transform is performed in the row direction on the two-dimensional data D1. During the one-dimensional transform, data is read from the auxiliary storage device for each set when column direction one-dimensional transform is performed, row-direction one-dimensional transform is performed, and then a part of the column-direction one-dimensional transform is performed.

For example, when the data D1 is data of M rows and N columns and M=R^{m}, R rows are collectively read, row direction one-dimensional transform is performed on each of the R rows, and one-dimensional transform is performed on each column component of all the R rows. The row direction primary transform and the column direction primary transform are performed on all the M rows until a series of row direction one-dimensional transform is finished. When the one-dimensional transform is finished, the overall row direction one-dimensional transform is finished, and the processing of the first stage in the column direction is further finished.

There are m stages in total for the column direction one-dimensional transform. In the remaining m−1 stages, M/R sets of R rows necessary for one-dimensional transform in each stage are read, and column direction primary transform is performed on each set. This stage is repeated m−1 times.

In the second transform method, since access (reading and writing) of M rows from the auxiliary storage device is repeated m times, a total number of accesses from the auxiliary storage device is as shown in Table 2. Here, m=log_{R}M.

TABLE 2

| | |
|---|---|
| Read | Write |
| Row | Row |

| Number of | Number of | Number of | Number of |
|---|---|---|---|
| elements | times | elements | times |
| N | M × m | N | M × m |

In a case where data before and after transform and intermediate data are recorded in the auxiliary storage device, and some data necessary for processing is read from the auxiliary storage device to the main storage device and processed, an access time to the auxiliary storage device is longer than a calculation time in a processor such as a central processing unit (CPU). Therefore, the access time to the auxiliary storage device is very important for the entire processing time. Tables 1 and 2 show the number of accesses to the auxiliary storage device in the first transform method and the second transform method disclosed in Non Patent Literature 1.

For better understanding of the number of accesses to the auxiliary storage device, when N=M, the number of accesses in the first transform method is as shown in Table 3.

TABLE 3

| Read | | | | Write | |
|---|---|---|---|---|---|
| Row | | Column | | Row | |
| Number of | Number of | Number of | Number of | Number of | Number of |
| elements | times | elements | times | elements | times |
| M | 2M | M | 2M | M | 4M |

When N=M, the number of accesses in the second transform method is as shown in Table 4.

TABLE 4

| | |
|---|---|
| Read | Write |
| Row | Row |

| Number of | Number of | Number of | Number of |
|---|---|---|---|
| elements | times | elements | times |
| M | Mlog_{R}M | M | Mlog_{R}M |

As described above, the number of accesses to the auxiliary storage device is a very important problem for a multidimensional transform process, and further improvement of the number of accesses is required.

### CITATION LIST

### Non Patent Literature

Non Patent Literature 1: M. Onoe, “A Method for Computing Large-Scale Two-Dimensional Transform without Transposing Data Matrix”, Proceedings of the IEEE, Vol. 63, pp. 196-197, January 1975.

### SUMMARY

### Technical Problem

Embodiments of the present invention have been made to solve the above problems, and an object thereof is to further reduce the number of accesses to an auxiliary storage device and to speed up a two-dimensional transform process.

### Solution to Problem

According to embodiments of the present invention, there is provided a two-dimensional data transform device including a first column reading unit configured to read an element group of one or more columns in a column direction of original data from an auxiliary storage device in which respective elements of the original data of M rows and N columns (where M and N are integers of 2 or greater) are continuously recorded in order in a row direction on the original data; a first one-dimensional transform unit configured to perform one-dimensional transform on the element group of one or more columns read by the first column reading unit every column with respect to all the read columns; a first row writing unit configured to write the element group of one or more columns transformed by the first one-dimensional transform unit into the auxiliary storage device as an element group of one or more rows in the row direction of intermediate data of N rows and M columns; a second column reading unit configured to read an element group of one or more columns in the column direction of the intermediate data from the auxiliary storage device after all of the original data is transformed and recorded in the auxiliary storage device as the intermediate data; a second one-dimensional transform unit configured to perform one-dimensional transform on the element group of one or more columns read by the second column reading unit every column with respect to all the read columns; and a second row writing unit configured to write the element group of one or more columns transformed by the second one-dimensional transform unit into the auxiliary storage device as an element group of one or more rows in the row direction of final data of M rows and N columns, in which the first column reading unit, the first one-dimensional transform unit, and the first row writing unit repeat processing until all of the original data is transformed and recorded in the auxiliary storage device as the intermediate data, and the second column reading unit, the second one-dimensional transform unit, and the second row writing unit repeat processing until all the intermediate data is transformed and recorded in the auxiliary storage device as the final data.

According to embodiments of the present invention, there is provided a two-dimensional data transform device including a column reading unit configured to read an element group of one or more columns in a column direction of input data that is two-dimensional data of M rows and N columns (where M and N are integers of 2 or greater) or N rows and M columns from an auxiliary storage device; a one-dimensional transform unit configured to perform one-dimensional transform on the element group of one or more columns read by the column reading unit every column with respect to all the read columns; a row writing unit configured to write the element group of one or more columns transformed by the one-dimensional transform unit into the auxiliary storage device as an element group of one or more rows in a row direction of output data that is two-dimensional data of N rows and M columns or M rows and N columns; a first data switching unit configured to, for the auxiliary storage device in which respective elements of original data of M rows and N columns are continuously recorded in order in the row direction on the original data, perform switching of an input of the column reading unit such that the original data becomes the input data, and perform switching of an input of the column reading unit such that the intermediate data becomes the input data after all of the original data is transformed and recorded in the auxiliary storage device as intermediate data of N rows and M columns; and a second data switching unit configured to perform switching of an output of the row writing unit such that the intermediate data becomes the output data, and perform switching of an output of the row writing unit such that final data of M rows and N columns becomes the output data after all of the original data is transformed and recorded in the auxiliary storage device as the intermediate data, in which the column reading unit, the one-dimensional transform unit, and the row writing unit repeat processing until all of the original data is transformed and recorded in the auxiliary storage device as the intermediate data, and further repeat processing until all of the intermediate data is transformed and recorded in the auxiliary storage device as the final data.

According to embodiments of the present invention, there is provided a two-dimensional data transform method including a first step of reading an element group of one or more columns in a column direction of original data from an auxiliary storage device in which respective elements of the original data of M rows and N columns (where M and N are integers of 2 or greater) are continuously recorded in order in a row direction on the original data; a second step of performing one-dimensional transform on the element group of one or more columns read in the first step every column with respect to all the read columns; a third step of writing the element group of one or more columns transformed in the second step into the auxiliary storage device as an element group of one or more rows in the row direction of intermediate data of N rows and M columns; a fourth step of reading an element group of one or more columns in the column direction of the intermediate data from the auxiliary storage device after all of the original data is transformed and recorded in the auxiliary storage device as the intermediate data; a fifth step of performing one-dimensional transform on the element group of one or more columns read in the fourth step every column with respect to all the read columns; and a sixth step of writing the element group of one or more columns transformed in the fifth step into the auxiliary storage device as an element group of one or more rows in the row direction of final data of M rows and N columns, in which, in the first step, the second step, and the third step, processing is repeated until all of the original data is transformed and recorded in the auxiliary storage device as the intermediate data, and, in the fourth step, the fifth step, and the sixth step, processing is repeated until all the intermediate data is transformed and recorded in the auxiliary storage device as the final data.

According to embodiments of the present invention, there is provided a two-dimensional data transform method including a first step of setting original data as input data and setting intermediate data of N rows and M columns as output data for an auxiliary storage device in which respective elements of the original data of M rows and N columns (where M and N are integers of 2 or greater) are continuously recorded in order in a row direction on the original data; a second step of reading an element group of one or more columns in the column direction of the input data from the auxiliary storage device; a third step of performing one-dimensional transform on the element group of one or more columns read in the second step every column with respect to all the read columns; a fourth step of writing the element group of one or more columns transformed in the third step into the auxiliary storage device as an element group of one or more rows in the row direction of the output data; a fifth step of setting the intermediate data as input data and setting final data of M rows and N columns as output data after all of the original data is transformed and recorded in the auxiliary storage device as the intermediate data; a sixth step of reading an element group of one or more columns in the column direction of the input data from the auxiliary storage device; a seventh step of performing one-dimensional transform on the element group of one or more columns read in the sixth step every column with respect to all the read columns; and an eighth step of writing the element group of one or more columns transformed in the seventh step into the auxiliary storage device as an element group of one or more rows in the row direction of the output data, in which, in the second step, the third step, and the fourth step, processing is repeated until all of the original data is transformed and recorded in the auxiliary storage device as the intermediate data, and, in the sixth step, the seventh step, and the eighth step, processing is repeated until all the intermediate data is transformed and recorded in the auxiliary storage device as the final data.

According to embodiments of the present invention, there is provided a program causing a computer to execute each of the above steps.

### Advantageous Effects of Embodiments of the Invention

According to embodiments of the present invention, by repeating reading of one or more columns, one-dimensional transform of one or more columns, and writing of one or more rows until all of the original data is transformed and recorded in the auxiliary storage device as intermediate data, and further repeating reading of one or more columns, one-dimensional transform of one or more columns, and writing of one or more rows until all of the intermediate data is transformed and recorded in the auxiliary storage device as final data, the number of accesses to the auxiliary storage device can be reduced, and a speed of the two-dimensional transform process can be increased.

### BRIEF DESCRIPTION OF THE DRAWINGS

FIGS. 1A and 1B are diagrams for describing a positional relationship between two-dimensional data and data in an auxiliary storage device.

FIGS. 2A to 2D are diagrams for describing two-dimensional data to be processed in embodiments of the present invention.

FIG. 3 is a block diagram illustrating a configuration of a two-dimensional data transform device according to a first embodiment of the present invention.

FIG. 4 is a flowchart for describing an operation of the two-dimensional data transform device according to the first embodiment of the present invention.

FIG. 5 is a flowchart for describing an operation of the two-dimensional data transform device according to the first embodiment of the present invention.

FIGS. 6A and 6B are diagrams for describing a positional relationship between two-dimensional data and data in the auxiliary storage device.

FIG. 7 is a flowchart for describing an operation of a two-dimensional data transform device according to a second embodiment of the present invention.

FIG. 8 is a flowchart for describing an operation of the two-dimensional data transform device according to the second embodiment of the present invention.

FIG. 9 is a block diagram illustrating a configuration of a two-dimensional data transform device according to a third embodiment of the present invention.

FIG. 10 is a flowchart for describing an operation of the two-dimensional data transform device according to the third embodiment of the present invention.

FIG. 11 is a flowchart for describing an operation of the two-dimensional data transform device according to the third embodiment of the present invention.

FIG. 12 is a block diagram illustrating a configuration example of a computer that implements the two-dimensional data transform device according to the first to third embodiments of the present invention.

### DETAILED DESCRIPTION OF ILLUSTRATIVE EMBODIMENTS

### Principle of Embodiments of the Invention

In signal processing for handling large-volume data that cannot be processed with a capacity of a main storage device of a computer, original data, intermediate data being processed, and final data after completion of processing are recorded in an auxiliary storage device such as a magneto-optical disc, a digital versatile disc (DVD), an optical disc such as a Blu-ray disc, or a hard disk, and data is read from the auxiliary storage device to the main storage device as necessary to perform signal processing.

The auxiliary storage device is also referred to as a block device, and is accessed (reading and writing) for each aggregation of multi-byte data called a block. The block may also be referred to as a sector or a cluster. An address is assigned to the block. Blocks of continuous addresses are substantially adjacent in positions on a recording medium. Thus, a speed of accessing a block group of continuous addresses is higher than in a case of accessing a block group of discrete addresses.

However, in a case where data is recorded across a plurality of tracks of a disk, a track movement time (seek time) of a head and a rotation waiting time of the disk are required, and thus access is slightly delayed. In a case where a substitute block is used instead of a defective block, positions of the defective block and the substitute block on the recording medium are separated from each other, and thus access to the substitute block may be delayed.

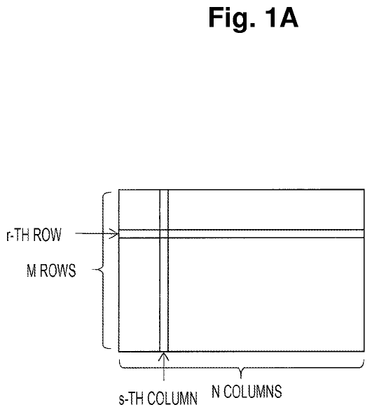

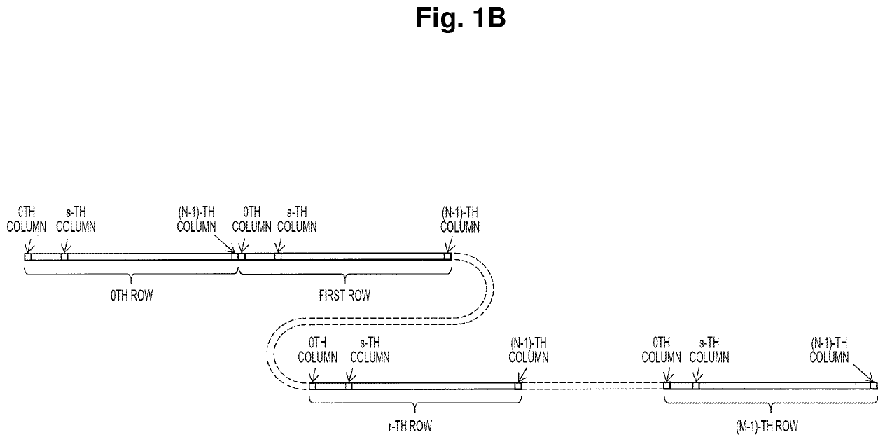

As described above, in the auxiliary storage device, an access speed varies depending on disposition of data. A result of actually measuring an access time of two-dimensional data to the auxiliary storage device by using a hard disk as the auxiliary storage device will be described below. Here, two-dimensional data is data having an element group of M rows and N columns as illustrated in FIG. 1A. In the auxiliary storage device, as illustrated in FIG. 1B, each element included in each row is continuously recorded in the order of arrangement on the two-dimensional data, and is recorded in the order of a 0th row, a first row, . . . , an r-th row, . . . , and an (M−1)-th row. Here, a leading row is set to the 0th row.

In the recording method illustrated in FIG. 1B, an element group in the s-th column is ideally recorded in the auxiliary storage device discretely for every N elements. Here, “ideally” means that, in a case where the auxiliary storage device is a hard disk, when there is a defective block, data is recorded in a substitute block instead of the defective block, and thus, even if logical blocks are continuous, physical blocks are discontinuous. In a case where two-dimensional data is recorded in the auxiliary storage device according to the method illustrated in FIG. 1B, it is expected that data access in the row direction is faster than data access in the column direction.

The two-dimensional data used in the measurement of the access time has elements of 5000 rows and 5000 columns. The element imitates a complex number and is data of two double-precision floating-point numbers (8 bytes×2). The elements are recorded in the auxiliary storage device such that block addresses are continuous in the row direction, such as the 0th row, the first row, . . . , and the 4999th row.

The environment used is as follows. A capacity of the hard disk used is 2 TB, an interface with the computer is the Universal Serial Bus (USB) 2.0, software used for the measurement is LabVIEW (registered trademark) 2019, and a read/write function capable of accessing binary data is used. In the computer used, a CPU is the Xeon (registered trademark) processor E3-1240v5@3.5 GHz manufactured by Intel Corporation, a capacity of the memory is 8 GB, an operating system (OS) is Windows (registered trademark) 10 Enterprise ver. 1903, and a write cache is disabled.

Access time measurement results are shown in Table 5. Since the elapsed time shown in Table 5 is a time from the start to the end of processing, the elapsed time also includes a processing time of a program such as an operating system operating in parallel.

TABLE 5

| | Elapsed time |
|---|---|
| Condition | (seconds) |
| Read one row at one time | 0.459804 |
| (read 5000 rows) | |
| Write one row at one time | 13.25673 |
| (write 5000 rows) | |
| Read one column at one time | 357.0288 |
| (read 5000 columns) | |
| Write one column at one time | 465.7032 |
| (write 5000 columns) | |

When the time for reading one row at one time is trl, the time for writing one row at one time is twl, the time for reading one column at one time is trc, and the time for writing one column at one time is twc, based on trl, twl≈30 trl, trc≈780 trl, and twc≈1010 trl are obtained according to Table 5. In terms of magnitude relationship, trl<<twl<<trc<twc is obtained. Here, “A<B” simply indicates that B is larger than A, and “A<<B” indicates that B is much larger than A.

Incidentally, as a method of performing two-dimensional transform, the following two methods (1) and (2) may be considered. The transform referred to here is a type of two-dimensional transform in which the base function can be separated into two variables, such as two-dimensional Fourier transform or two-dimensional Hadamard transform.

(1) A method in which one-dimensional transform is first performed in each column direction on all columns, and then one-dimensional transform is performed in each row direction on all rows.

(2) A method in which one-dimensional transform is first performed in each row direction on all rows, and then one-dimensional transform is performed in each column direction on all columns.

In embodiments of the present invention, two-dimensional transform is performed in the order in the method (1), and as a specific method of performing this calculation, (1-1) and (1-2) below are performed. However, in the description of (1-1) and (1-2), it is assumed that original data before transform is two-dimensional data of M rows and N columns, and rows and columns of the two-dimensional data are counted from 0. Two-dimensional data after the process in (1-1) will be referred to as intermediate data, and two-dimensional data after the process in (1-2) will be referred to as final data.

(1-1) An element group in a j-th column (where j is an integer of 0 to N−1) from the original data before transform is read, one-dimensional transform is performed, and writing of the element group after the one-dimensional transform as an element group in a j-th row of the intermediate data is executed on all columns (0th to (N−1)-th columns) of the original data.

(1-2) An element group in an i-th column (where i is an integer of 0 to M−1) from the intermediate data after the process in (1-1) is read, one-dimensional transform is performed, and writing of the element group after the one-dimensional transform as an element group in an i-th row of final data is executed on all columns (0th to (M−1)-th columns) of the intermediate data.

According to embodiments of the present invention, the process is performed in the order in the method (1), and there is a reason for this. As described above, according to the experiment, there is a relationship of trl>>twl>>trc<twc. In a case where the process is performed in the order in the method (1), only reading of the column and writing of the row are performed, and thus the processing time relates to trc and twl. On the other hand, in a case where the process is performed in the order in the method (2), the processing time relates to trl and twc. Since trl and twl are much smaller than twc and twl, the processing time is regulated approximately by twc and trc. Since trc<twc, the processing time is shorter in the order in the method (1).

As described above, in embodiments of the present invention, in order to reduce the processing time of the two-dimensional transform, row data in which the data is recorded in continuous blocks of the auxiliary storage device is written, and column data is read.

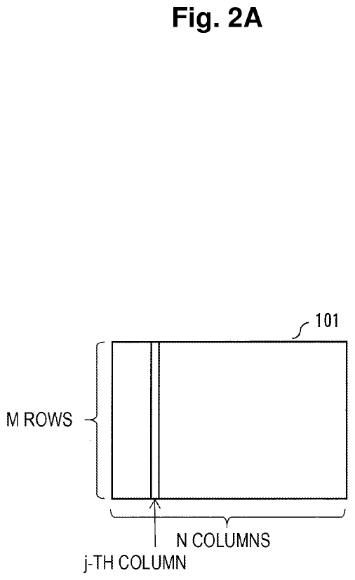

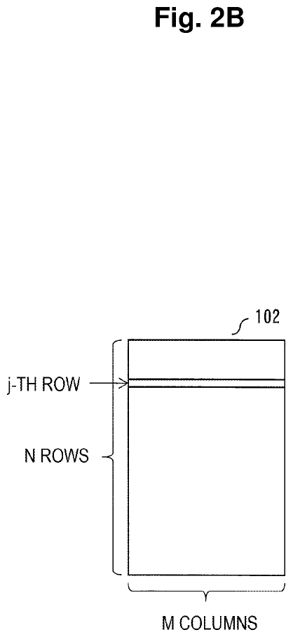

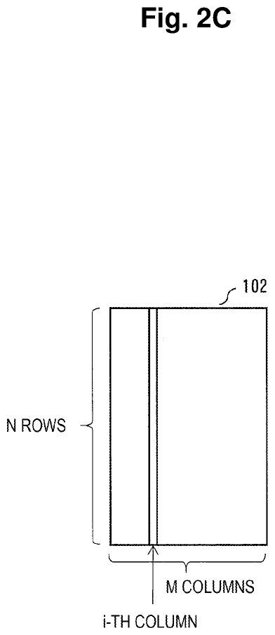

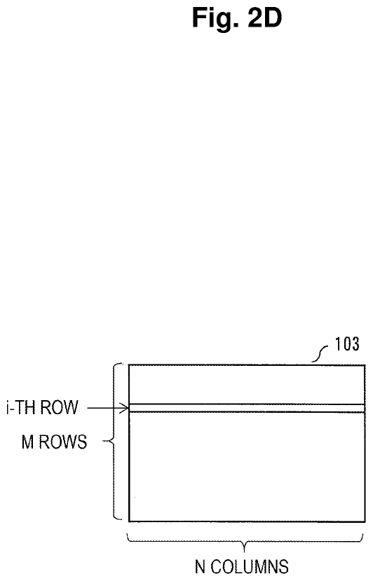

For the process of embodiments of the present invention, a relationship between rows and columns is illustrated in FIGS. 2A, 2B, 2C, and 2D. FIG. 2A illustrates original data 101 which is two-dimensional data of M rows and N columns, and illustrates a position of the element group in the j-th column in the above (1-1). FIG. 2B illustrates intermediate data 102 which is two-dimensional data of N rows and M columns, and illustrates a position of the element group in the j-th row in the above (1-1).

FIG. 2C illustrates the intermediate data 102, and illustrates a position of the element group in the i-th column in the above (1-2). FIG. 2D illustrates final data 103 which is two-dimensional data of M rows and N columns, and illustrates a position of the element group in the i-th row in the above (1-2).

Embodiments of the present invention are similar to the method using matrix transposition disclosed in Non Patent Literature 1, but is actually different. In order to compare the method of embodiments of the present invention with the method using matrix transposition disclosed in Non Patent Literature 1, the method disclosed in Non Patent Literature 1 is shown in (2-1) to (2-4).

(2-1) An element group in an i-th row from original data for transformed data is read, one-dimensional transform is performed, and writing of elements after the one-dimensional transform as an element group in an i-th row of first intermediate data is executed on all rows (0th to (M−1)-th rows).

(2-2) The first intermediate data is transposed (the element group in the j-th column is read and written as an element group in a j-th row) to generate second intermediate data.

(2-3) The element group in the j-th row is read from the second intermediate data, one-dimensional transform is performed, and writing of an element group after the one-dimensional transform as an element group in a j-th row of third intermediate data is executed on all the rows (0th to (N−1)-th rows).

(2-4) The third intermediate data is transposed (the element group in the i-th column is read and written as an element group in an i-th row) to generate final data.

In order to compare the method of embodiments of the present invention with the method using matrix transposition disclosed in Non Patent Literature 1, the number of times of reading, the number of times of writing, and the number of times of one-dimensional transform for the auxiliary storage device are written as shown in Tables 6 and 7.

TABLE 6
Present invention

| | Number of | Number of |
|---|---|---|
| Processing details | elements | times |
| One-column reading | M | N |
| One-column reading | N | M |
| One-row writing | M | N |
| One-row writing | N | M |
| One-dimensional transform | M | N |
| One-dimensional transform | N | M |

TABLE 7
Non patent literature 1

| | Number of | Number of |
|---|---|---|
| Processing details | elements | times |
| One-column reading | M | N |
| One-column reading | N | M |
| One-row reading | M | N |
| One-row reading | N | M |
| One-row writing | M | 2N |
| One-row writing | N | 2M |
| One-dimensional transform | M | N |
| One-dimensional transform | N | M |

According to Tables 6 and 7, one-row reading of the number of elements M is smaller by N times, and one-row reading of the number of elements N is smaller by M times in embodiments of the present invention than in the method using matrix transposition disclosed in Non Patent Literature 1. In embodiments of the present invention, one-row writing of the number of elements M is smaller by N times, and one-row writing of the number of elements N is smaller by M times.

Therefore, according to embodiments of the present invention, the processing time can be reduced.

In the processes in (1-1) and (1-2) of embodiments of the present invention, the same process (one-column reading, one-column one-dimensional transform, and one-row writing) is performed. Therefore, in execution of the processes in (1-1) and (1-2), since hardware or software (a software subroutine or a software function) that performs the same process can be used, calculation resources can be reduced.

Reduction of calculation resources by performing the same process is similarly applied to the method using matrix transposition disclosed in Non Patent Literature 1. The process of the i-th row reading, the i-th row one-dimensional transform, and the i-th row writing in (2-1) and the process of the j-th row reading, the j-th row one-dimensional transform, and the j-th row writing in (2-3) are substantially the same process although there is a difference in the variables i and j. The process of the j-th column reading and the j-th row writing in (2-2) and the process of the i-th column reading and the i-th row writing in (2-4) are also the same process.

However, in embodiments of the present invention, since the matrix transposition process in (2-2) and (2-3) is unnecessary, calculation resources can be reduced compared with the method using matrix transposition disclosed in Non Patent Literature 1.

### First Embodiment

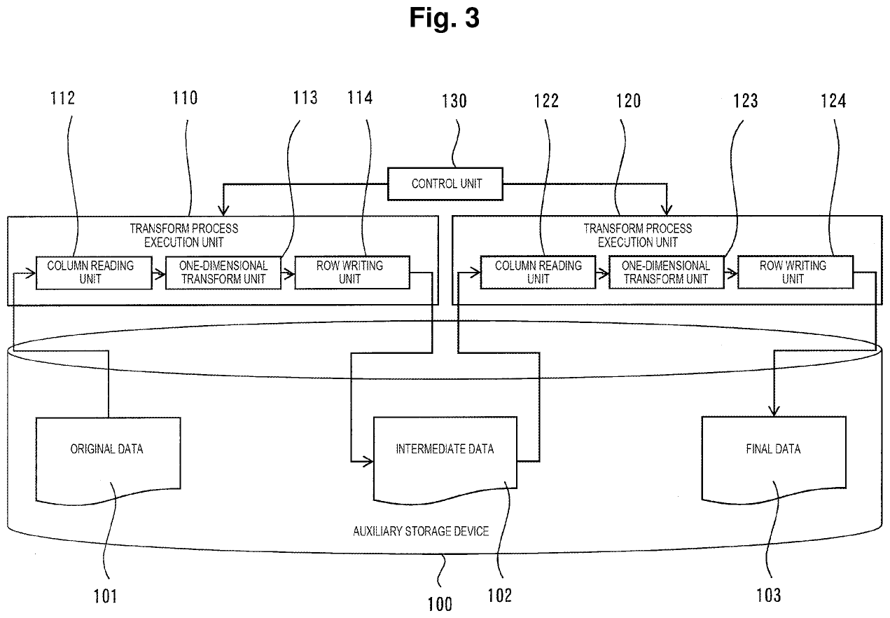

Hereinafter, embodiments of the present invention will be described with reference to the drawings. FIG. 3 is a block diagram illustrating a configuration of a two-dimensional data transform device according to a first embodiment of the present invention. The two-dimensional data transform device includes an auxiliary storage device 100, a transform process execution unit 110, a transform process execution unit 120, and a control unit 130.

The transform process execution unit 110 includes a column reading unit 112 that reads an element group of one column in the column direction of the original data 101 before transform from the auxiliary storage device 100, a one-dimensional transform unit 113 that performs one-dimensional transform on the element group read by the column reading unit 112, and a row writing unit 114 that writes the element group of one column transformed by the one-dimensional transform unit 113 into the auxiliary storage device 100 as an element group of one row of the intermediate data 102.

The transform process execution unit 120 includes a column reading unit 122 that reads an element group of one column in the column direction of the intermediate data 102 from the auxiliary storage device 100 after all of the original data 101 is transformed and recorded in the auxiliary storage device 100 as the intermediate data 102, a one-dimensional transform unit 123 that performs one-dimensional transform on the element group read by the column reading unit 122, and a row writing unit 124 that writes the element group of one column transformed by the one-dimensional transform unit 123 into the auxiliary storage device 100 as an element group of one row of the final data 103.

In the present embodiment, it is assumed that the original data 101 before transform is two-dimensional data of M rows and N columns, and rows and columns of the two-dimensional data are counted from 0. That is, each column of the two-dimensional data of M rows and N columns is specified as 0 to N−1 columns, and each row is specified as 0 to M−1 rows. The following variables i and j are integers of 0 or greater.

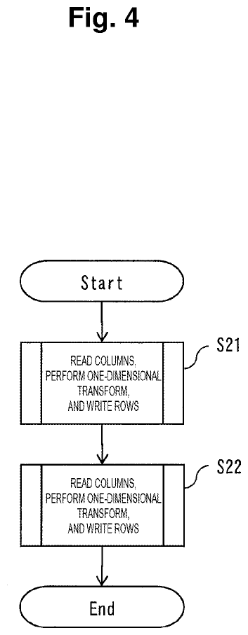

FIG. 4 is a flowchart for describing an operation of the two-dimensional data transform device of the present embodiment. The control unit 130 and the transform process execution unit no read an element group in the column direction from the original data 101 before transform for each column, perform one-dimensional transform, and write the element group after the one-dimensional transform as an element group in the row direction of the intermediate data 102 (step S21 in FIG. 4).

Specifically, the control unit 130 instructs the column reading unit 112 to read an element group in the j-th column of the original data 101 recorded in the auxiliary storage device 100.

The column reading unit 112 reads and outputs the element group in the j-th column of the original data 101 in response to the instruction from the control unit 130.

The one-dimensional transform unit 113 performs one-dimensional transform on the element group in the j-th column output from the column reading unit 112 and outputs the element group.

The row writing unit 114 writes the element group after the one-dimensional transform output from the one-dimensional transform unit 113 into the auxiliary storage device 100 as an element group in the j-th row of the intermediate data 102.

The control unit 130 controls the column reading unit 112, the one-dimensional transform unit 113, and the row writing unit 114 to sequentially perform the above process on each column (0th to (N−1)-th columns) of the original data 101.

The one-dimensional transform unit 113 and the row writing unit 114 do not have to receive an instruction from the control unit 130. That is, the one-dimensional transform unit 113 may perform an event-driven operation of inputting the element group in the j-th column, performing one-dimensional transform, and outputting the element group, in response to output of the element group in the j-th column from the column reading unit 112.

Similarly, the row writing unit 114 may perform an event-driven operation of writing the element group after the one-dimensional transform as the element group in the j-th row of the intermediate data 102 into the auxiliary storage device 100, in response to output of the element group after the one-dimensional transform from the one-dimensional transform unit 113.

The intermediate data 102 generated as described above is obtained by transposing data obtained by performing one-dimensional transform on each row of the original data 101, and becomes two-dimensional data of N rows and M columns.

Next, the control unit 130 and the transform process execution unit 120 read an element group in the i-th column from the intermediate data 102, perform one-dimensional transform, and write the element group after the one-dimensional transform as an element group in the i-th row of the final data 103 (step S22 in FIG. 4).

Specifically, the control unit 130 instructs the column reading unit 122 to read an element group in the i-th column of the intermediate data 102 recorded in the auxiliary storage device 100.

The column reading unit 122 reads and outputs an element group in the i-th column of the intermediate data 102 in response to an instruction from the control unit 130.

The one-dimensional transform unit 123 performs one-dimensional transform on the element group in the i-th column output from the column reading unit 122 and outputs the element group.

The row writing unit 124 writes the element group after the one-dimensional transform output from the one-dimensional transform unit 123 into the auxiliary storage device 100 as an element group in the i-th row of the final data 103.

The control unit 130 controls the column reading unit 122, the one-dimensional transform unit 123, and the row writing unit 124 to sequentially perform the above process on each column (0th to (N−1)-th columns) of the intermediate data 102.

The one-dimensional transform unit 123 and the row writing unit 124 do not have to receive an instruction from the control unit 130. That is, the one-dimensional transform unit 123 may perform an event-driven operation of inputting the element group in the i-th column, performing one-dimensional transform, and outputting the element group, in response to output of the element group in the i-th column from the column reading unit 122.

Similarly, the row writing unit 124 may perform an event-driven operation of writing the element group after the one-dimensional transform into the auxiliary storage device 100 as the element group in the i-th row of the final data 103, in response to output of the element group after the one-dimensional transform from the one-dimensional transform unit 123.

The final data 103 generated as described above is obtained by transposing data obtained by performing one-dimensional transform on each row of the intermediate data 102, and becomes two-dimensional data of M rows and N columns.

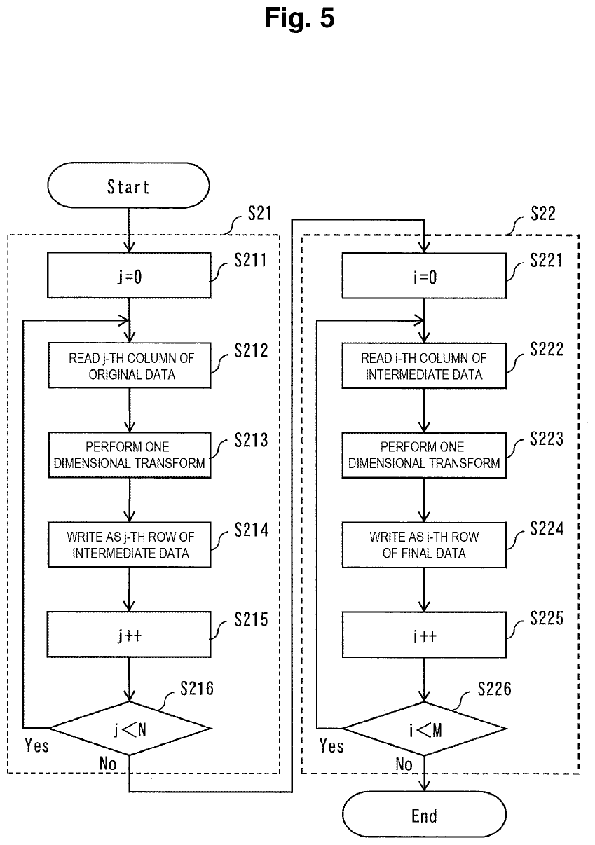

FIG. 5 is a flowchart more specifically describing the processes in steps S21 and S22 in FIG. 4. The control unit 130 initializes the variable j storing a designated column to 0 (step S211 in FIG. 5).

Subsequently, the control unit 130 issues a command for reading an element group in the j-th column to the column reading unit 112. The column reading unit 112 reads and outputs an element group in the j-th column of the original data 101 recorded in the auxiliary storage device 100 (step S212 in FIG. 5).

The one-dimensional transform unit 113 performs one-dimensional transform on the element group in the j-th column output from the column reading unit 112 and outputs the element group (step S213 in FIG. 5).

The row writing unit 114 writes the element group after the one-dimensional transform output from the one-dimensional transform unit 113 into the auxiliary storage device 100 as an element group in the j-th row of the intermediate data 102 (step S214 in FIG. 5).

The control unit 130 increases a value of the variable j by 1 (step S215 in FIG. 5). If the variable j is less than N (Yes in step S216 in FIG. 5), the control unit 130 returns to step S212, and if the variable j is N or more (No in step S216), the control unit proceeds to step S221.

The above steps S211 to S216 specifically describe the process in step S21.

Next, when the variable j becomes N or more, the control unit 130 initializes the variable i storing a designated row to 0 (step S221 in FIG. 5).

Subsequently, the control unit 130 issues a command for reading the i-th column to the column reading unit 122. The column reading unit 122 reads and outputs an element group in the i-th column of the intermediate data 102 recorded in the auxiliary storage device 100 (step S222 in FIG. 5).

The one-dimensional transform unit 123 performs one-dimensional transform on the element group in the i-th column output from the column reading unit 122 and outputs the element group (step S223 in FIG. 5).

The row writing unit 124 writes the element group after the one-dimensional transform output from the one-dimensional transform unit 123 into the auxiliary storage device 100 as an element group in the i-th row of the final data 103 (step S224 in FIG. 5).

The control unit 130 increases a value of the variable i by 1 (step S225 in FIG. 5). If the variable i is less than M (Yes in step S226 in FIG. 5), the control unit 130 returns to step S222, and in a case where the variable i is M or more (No in step S226), finishes the two-dimensional transform process.

The above steps S221 to S226 specifically describe the process in step S22.

Thus, in the present embodiment, the number of accesses to the auxiliary storage device 100 can be reduced, and a speed of the two-dimensional transform process can be increased.

### Second Embodiment

In the first embodiment, the method in which the column reading units 112 and 122 read one column at one time and the row writing units 114 and 124 write one row at one time has been described. However, reading of a plurality of columns at one time or writing of a plurality of rows at one time may be performed.

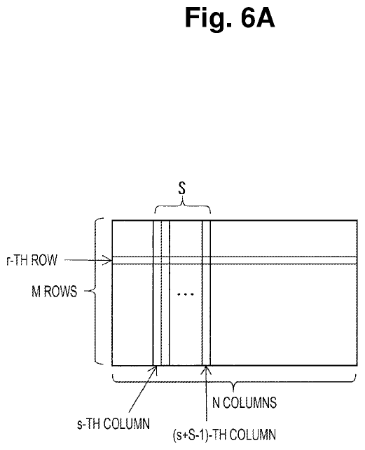

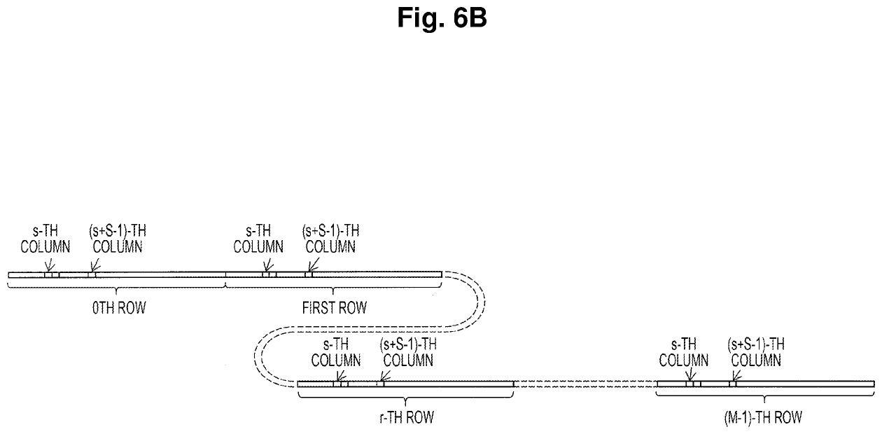

For example, when the two-dimensional data is data having elements of M rows and N columns as illustrated in FIG. 6A, in the auxiliary storage device, as illustrated in FIG. 6B, element groups of each row are continuously recorded in the order of arrangement on the two-dimensional data, and are recorded in the order of a 0th row, a first row, . . . , an r-th row, . . . , and an (M−1)-th row. In this case, elements in s-th to (s+S−1)-th columns of each row (an element group of S columns starting from the s-th column) are continuously recorded in the auxiliary storage device.

Therefore, if elements are read in the order of elements in the s-th column of the 0th row→elements in the (s+1)-th column of the 0th row→ . . . →elements in the (s+S−1)-th column of the 0th column→elements in the s-th column of the first row→elements in the (s+1)-th column of the first row→ . . . →elements in the (s+S−1)-th column of the first column→ . . . →elements in the s-th column of the (M−1)-th row→elements in the (s+1)-th column in the (M−1)-th row→ . . . →elements in the (s+S−1)-th column of the (M−1)-th row, it is expected that a reading speed will be high. [ono] A result of actually measuring a read time of two-dimensional data from the auxiliary storage device by using a hard disk as the auxiliary storage device will be described below. The two-dimensional data used in the measurement has elements of 10000 rows and 10000 columns. The element imitates a complex number and is data of two double-precision floating-point numbers (8 bytes×2). The elements are recorded in the auxiliary storage device such that block addresses are continuous in the row direction, such as the first row, the second row, . . . , and the 10000th row.

The environment used is as follows. A capacity of the hard disk used is 2 TB, an interface with the computer is USB 2.0, software used for the measurement is LabVIEW 2019, and a read/write function capable of accessing binary data is used. In the computer used, a CPU is the Xeon processor E3-1240v5@3.5 GHz manufactured by Intel Corporation, a capacity of the memory is 8 GB, an OS is Windows 10 Enterprise ver. 1903, and a write cache is disabled.

Elapsed time measurement results in a read process are shown in Table 8. The elapsed time shown in Table 8 is a time difference between the processing start time and the processing end time, and thus also includes a processing time of a program such as an operating system operating in parallel.

TABLE 8

| | Elapsed time |
|---|---|
| Condition | (seconds) |
| Read one column at one time | 934.1293 |
| (read 10000 columns) | |
| Read two columns at one time | 465.5054 |
| (read 10000 columns) | |
| Read five columns at one time | 188.5274 |
| (read 10000 columns) | |
| Read ten columns at one time | 94.7580 |
| (read 10000 columns) | |

It can be seen that the elapsed time of the read process can be reduced by reading a plurality of columns at one time in the above order. In the example of Table 8, the elapsed time of the read process is reduced in substantially inverse proportion to the number of columns S to be read at one time. The results in Table 8 indicate that the elapsed time of the read process in the column direction is extremely short with respect to the elapsed time of the read process in the row direction, and the time for reading the elements of S=2 to 10 in the row direction is at a substantially negligible level with respect to the time for reading one element at one time in the column direction.

Next, the second embodiment corresponding to the present embodiment will be described in more detail. Also in the present embodiment, since a configuration of the two-dimensional data transform device is similar to that of the first embodiment, the description will be made by using reference numerals in FIG. 3.

Also in the present embodiment, similarly to the first embodiment, it is assumed that the original data 101 before transform is two-dimensional data of M rows and N columns, and rows and columns of the two-dimensional data are counted from 0. That is, each column of the two-dimensional data of M rows and N columns is specified as 0 to N−1 columns, and each row is specified as 0 to M−1 rows. The following variables l and j are integers of 0 or greater. Constants P and Q are predetermined integers of 1 or greater. The variables l and k are integers of 1 or greater.

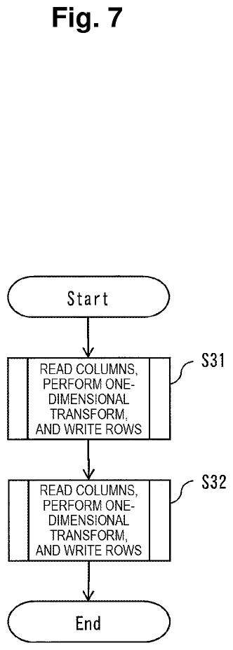

FIG. 7 is a flowchart for describing an operation of the two-dimensional data transform device of the present embodiment. The control unit 130 and the transform process execution unit no read an element group of l columns in the column direction from the original data 101 before transform, perform one-dimensional transform, and write the element group after the one-dimensional transform into the auxiliary storage device 100 as an element group of l rows of the intermediate data 102 (step S31 in FIG. 7).

Specifically, the control unit 130 sets the variable l=N−j if the variable j+Q>N, and sets the variable l=Q if the variable j+Q≤N. Subsequently, the control unit 130 instructs the column reading unit 112 to read an element group in the j-th to (j+l−1)-th columns (l columns starting from the j-th column) of the original data 101 recorded in the auxiliary storage device 100.

In response to the instruction from the control unit 130, the column reading unit 112 reads and outputs the element group in the j-th to (j+l−1)-th columns of the original data 101.

The one-dimensional transform unit 113 performs one-dimensional transform on the element group in the j-th to (j+l−1)-th columns output from the column reading unit 112 and outputs the element group.

The row writing unit 114 writes the element group after the one-dimensional transform output from the one-dimensional transform unit 113 into the auxiliary storage device 100 as an element group in the j-th to (j+l−1)-th rows (l rows starting from the j-th row) of the intermediate data 102.

The control unit 130 performs control such that the column reading unit 112, the one-dimensional transform unit 113, and the row writing unit 114 perform the above process on all columns (0th to (N−1)-th columns) of the original data 101. In an actual process, reading the element group in the j-th to (j+l−1)-th columns of the original data 101, performing one-dimensional transform, and writing the element group after the one-dimensional transform as the element group in the j-th to (j+l−1)-th rows of the intermediate data 102 are repeated while updating the variables j and l.

The variable l is equal to the constant Q except at the time of processing the last l columns (j=Q×(ceil(N/Q)−1, where ceil(x) is the smallest integer greater than x). At the time of processing the last l columns satisfying j+Q>N, the variable l=N−j.

The one-dimensional transform unit 113 and the row writing unit 114 do not have to receive an instruction from the control unit 130. That is, the one-dimensional transform unit 113 may perform an event-driven operation of inputting the element group of l columns, performing one-dimensional transform, and outputting the element group, in response to output of the element group of l columns from the column reading unit 112.

Similarly, the row writing unit 114 may perform an event-driven operation of writing the element group of l columns after one-dimensional transform into the auxiliary storage device wo as an element group in the j-th to (j+l−1)-th rows (l rows starting from the j-th row) of the intermediate data 102, in response to output of the element group of l columns after the one-dimensional transform from the one-dimensional transform unit 113.

The intermediate data 102 generated as described above is obtained by transposing data obtained by performing one-dimensional transform on each row of the original data 101, and becomes two-dimensional data of N rows and M columns.

Next, the control unit 130 and the transform process execution unit 120 read an element group of k columns in the column direction from the intermediate data 102, perform one-dimensional transform, and write the element group after the one-dimensional transform into the auxiliary storage device wo as an element group of k rows of the final data 103 (step S32 in FIG. 7).

Specifically, the control unit 130 sets the variable k=M−i if the variable i+P>M, and sets the variable k=P if the variable i+P≤M. Subsequently, the control unit 130 instructs the column reading unit 122 to read an element group in the i-th to (i+k−1)-th columns (k columns starting from the i-th column) of the intermediate data 102 recorded in the auxiliary storage device 100.

In response to the instruction from the control unit 130, the column reading unit 122 reads and outputs the element group in the i-th to (i+k−1)-th columns of the intermediate data 102.

The one-dimensional transform unit 123 performs one-dimensional transform on the element group in the i-th to (i+k−1)-th columns output from the column reading unit 122, and outputs the element group.

The row writing unit 124 writes the element group after the one-dimensional transform output from the one-dimensional transform unit 123 into the auxiliary storage device 100 as an element group in the i-th to (i+k−1)-th rows of the final data 103 (k rows starting from the i-th row).

The control unit 130 controls the column reading unit 122, the one-dimensional transform unit 123, and the row writing unit 124 to perform the above process on all columns (0th to (M−1)-th columns) of the intermediate data 102. In an actual process, reading the element group in the i-th to (i+k−1)-th columns of the intermediate data 102, performing one-dimensional transform, and writing the element group after the one-dimensional transform as the element group in the i-th to (i+k−1)-th rows of the final data 103 are repeated while updating the variables i and k.

The variable k is equal to the constant P except at the time of processing the last k columns (i=P×(ceil(M/P)−1)). At the time of processing the last k columns satisfying i+P>M, the variable k=M−i.

The one-dimensional transform unit 123 and the row writing unit 124 do not have to receive an instruction from the control unit 130. That is, the one-dimensional transform unit 123 may perform an event-driven operation of inputting the element group of k columns, performing one-dimensional transform, and outputting the element group, in response to output of the element group of k columns from the column reading unit 122.

Similarly, the row writing unit 124 may perform an event-driven operation of writing the element group of k columns after one-dimensional transform as an element group in the i-th to (i+k−1)-th rows of the final data 103 (k rows starting from the i-th row) into the auxiliary storage device 100, in response to output of the element group of k columns after the one-dimensional transform from the one-dimensional transform unit 123.

The final data 103 generated as described above is obtained by transposing data obtained by performing one-dimensional transform on each row of the intermediate data 102, and becomes two-dimensional data of M rows and N columns.

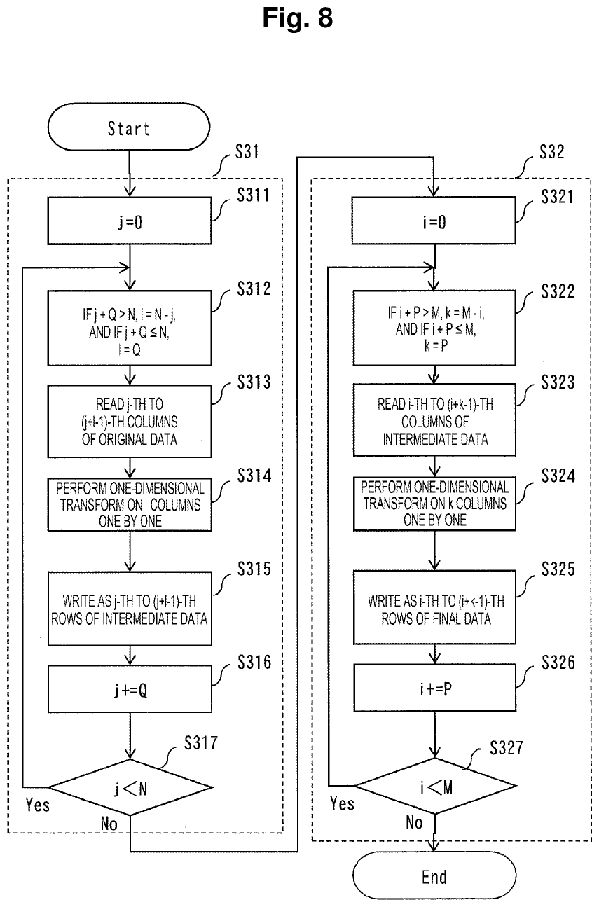

FIG. 8 is a flowchart more specifically describing the processes in steps S31 and S32 in FIG. 7. The control unit 130 initializes the variable j storing a designated column to 0 (step S311 in FIG. 8). The control unit 130 sets the variable l=N−j if the variable j+Q>N, and sets the variable l=Q if the variable j+Q≤N (step S312 in FIG. 8).

Subsequently, the control unit 130 issues a command for reading an element group in the j-th to (j+l−1)-th columns (l columns starting from the j-th column) to the column reading unit 112. The column reading unit 112 reads and outputs the element group in the j-th to (j+l−1)-th columns of the original data 101 recorded in the auxiliary storage device 100 (step S313 in FIG. 8).

The one-dimensional transform unit 113 performs one-dimensional transform on the element group in the j-th to (j+l−1)-th columns output from the column reading unit 112 one by one and outputs the element groups (step S314 in FIG. 8).

The row writing unit 114 writes the element group after the one-dimensional transform output from the one-dimensional transform unit 113 into the auxiliary storage device 100 as an element group in the j-th to (j+l−1)-th rows (l rows starting from the j-th row) of the intermediate data 102 (step S315 in FIG. 8).

The control unit 130 increases a value of the variable j by Q (step S316 in FIG. 8). If the variable j is less than N (Yes in step S317 in FIG. 8), the control unit 130 returns to step S312, and if the variable j is N or more (No in step S317), the control unit proceeds to step S321.

The above steps S311 to S317 specifically describe the process in step S31.

Next, when the variable j becomes N or more, the control unit 130 initializes the variable i storing a designated column to 0 (step S321 in FIG. 8). The control unit 130 sets the variable k=M−i if the variable i+P>M, and sets the variable k=P if the variable i+P≤M (step S322 in FIG. 8).

Subsequently, the control unit 130 issues a command for reading an element group in the i-th to (i+k−1)-th columns (k columns starting from the i-th column) to the column reading unit 122. The column reading unit 122 reads and outputs the element group in the i-th to (i+k−1)-th columns of the intermediate data 102 recorded in the auxiliary storage device 100 (step S323 in FIG. 8).

The one-dimensional transform unit 123 performs one-dimensional transform on the element group in the i-th to (i+k−1)-th columns output from the column reading unit 122 one by one and outputs the element groups (step S324 in FIG. 8).

The row writing unit 124 writes the element group after the one-dimensional transform output from the one-dimensional transform unit 123 into the auxiliary storage device 100 as an element group in the i-th to (i+k−1)-th rows (k rows starting from the i-th row) of the final data 103 (step S325 in FIG. 8).

The control unit 130 increases a value of the variable i by P (step S326 in FIG. 8). If the variable i is less than M (Yes in step S327 in FIG. 8), the control unit 130 returns to step S322, and if the variable i is M or more (No in step S327), finishes the two-dimensional transform process.

The above steps S321 to S327 specifically describe the process in step S32.

The results of measuring the processing time in the present embodiment, the first embodiment, and the method using matrix transposition disclosed in Non Patent Literature 1 are shown below. In the present embodiment, the number of columns Q and P to be read at one time is set to ten (Q and P=10). In this measurement, the one-dimensional transform process is a one-dimensional fast Fourier transform (1D-FFT) process. As a reference example, a processing time in which 1D-FFT in the row direction is performed on all rows one by one and 1D-FFT in the column direction is performed on all columns one by one without speeding up the calculation is also described.

The two-dimensional data used in the measurement has elements of 10000 rows and 3000 columns. The element imitates a complex number and is data of two double-precision floating-point numbers (8 bytes×2). The elements are recorded in the auxiliary storage device such that block addresses are continuous in the row direction, such as the first row, the second row, . . . , and the 10000th row.

The environment used is as follows. A capacity of the hard disk used is 2 TB, an interface with the computer is USB 2.0, software used for the measurement is LabVIEW 2019, and a read/write function capable of accessing binary data is used. In the computer used, a CPU is the Xeon processor E3-1240v5@3.5 GHz manufactured by Intel Corporation, a capacity of the memory is 8 GB, an OS is Windows 10 Enterprise ver. 1903, and a write cache is disabled.

The measurement results of the elapsed time in the first embodiment are shown in Table 9, the measurement results of the elapsed time in the present embodiment are shown in Table 10, the measurement results of the elapsed time in the method disclosed in Non Patent Literature 1 are shown in Table 11, and the measurement results of the elapsed time in the reference example are shown in Table 12. The elapsed time shown in Tables 9 to 12 is a time difference between the processing start time and the processing end time, and thus also includes a processing time of a program such as an operating system operating in parallel.

TABLE 9
First actual measurement example

| | Elapsed time |
|---|---|
| Processing details | (seconds) |
| Column reading + one-dimensional | 296.0654 |
| transform + row writing | |
| Column reading + one-dimensional | 279.2848 |
| transform + row writing | |
| All processes | 575.3502 |

TABLE 10
Second actual measurement example

| | Elapsed time |
|---|---|
| Processing details | (seconds) |
| Column reading + one-dimensional | 31.2217 |
| transform + row writing | |
| Column reading + one-dimensional | 50.1448 |
| transform + row writing | |
| All processes | 81.3665 |

TABLE 11
Non patent literature 1

| | Elapsed time |
|---|---|
| Processing details | (seconds) |
| Row direction one-dimensional | 13.5056 |
| transform (all-row processing) | |
| Matrix transposition process | 330.6658 |
| Row direction one-dimensional | 1.4297 |
| transform (all-row processing) | |
| Matrix transposition process | 292.4220 |
| All processes | 638.0231 |

TABLE 12
Reference example

| | Elapsed time |
|---|---|
| Processing details | (seconds) |
| Row direction one-dimensional | 13.5652 |
| transform (all-row processing) | |
| Column direction one-dimensional | 758.0172 |
| transform (all-column processing) | |
| All processes | 771.5824 |

According to Tables 9 to 12, in the method using matrix transposition disclosed in Non Patent Literature 1, the elapsed time of all processes is about 638 seconds, whereas the elapsed time of the processing in the first embodiment is about 575 seconds, and the elapsed time of the processing of the present embodiment is about 81 seconds. In the first embodiment and the present embodiment, it can be seen that a speed of the two-dimensional transform process can be increased compared with the method disclosed in Non Patent Literature 1.

For reference, the elapsed time is about 772 seconds in the method without speeding up the calculation. It can be seen that the method using matrix transposition disclosed in Non Patent Literature 1 can achieve some speed-up.

Assuming that the elapsed time in the method disclosed in Non Patent Literature 1 is 1, the elapsed time of the processing of the first embodiment is about 0.90, and the elapsed time of the processing of the present embodiment is about 0.13. Therefore, compared with the method disclosed in Non Patent Literature 1, a speed in the first embodiment can be increased by about 1.1 (=1/0.90) times, and a speed in the present embodiment can be increased by about 7.8 (=1/0.13) times. Compared with the first embodiment, a speed in the present embodiment can be increased by about 7.1 (=7.8/1.1) times.

### Third Embodiment

The two-dimensional data transform devices of the first embodiment and the second embodiment include two transform process execution units. These two transform process execution units have the same processing details except that parameters (input data, output data, input data size (number of rows and number of columns), and number of columns read at one time) are different. Therefore, in the third embodiment of the present invention, an example in which one transform process execution unit is provided and resources are reduced will be described.

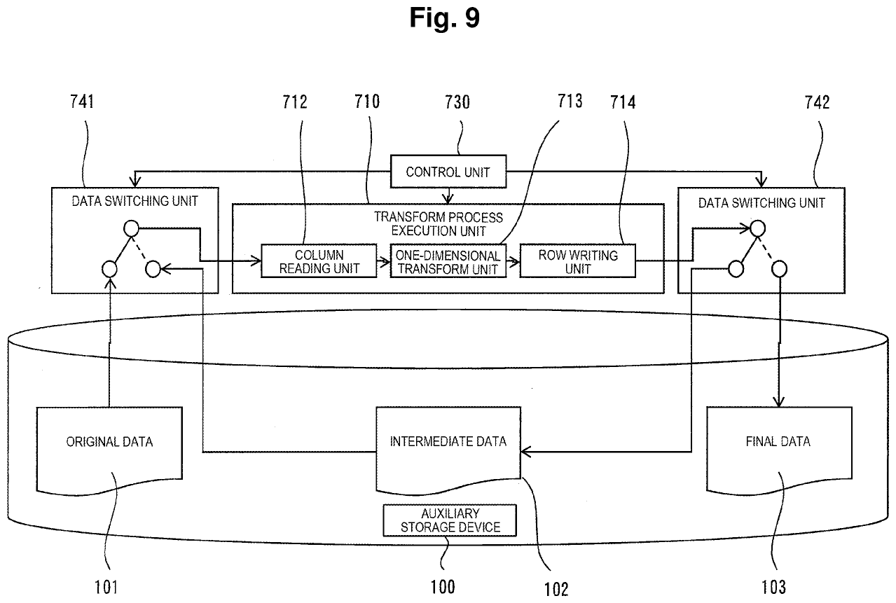

FIG. 9 is a block diagram illustrating a configuration of a two-dimensional data transform device according to the present embodiment. The two-dimensional data transform device of the present embodiment includes an auxiliary storage device 100, a transform process execution unit 710, a control unit 730, and data switching units 741 and 742.

The transform process execution unit 710 includes a column reading unit 712 that reads an element group of one or more columns in the column direction of the input data from the auxiliary storage device, a one-dimensional transform unit 713 that sequentially performs one-dimensional transform on the element group of the one or more columns read by the column reading unit 712, and a row writing unit 714 that writes the element group of one or more columns transformed by the one-dimensional transform unit 713 into the auxiliary storage device 100 as an element group of one or more rows in the row direction of the output data.

Also in the present embodiment, similarly to the second embodiment, the original data 101 before transform is set as two-dimensional data of M rows and N columns, and rows and columns of the two-dimensional data are counted from 0. That is, each column of the two-dimensional data of M rows and N columns is specified as 0 to N−1 columns, and each row is specified as 0 to M−1 rows. A variable i shown below is an integer of 0 or greater. Constants P and Q are predetermined integers of 1 or greater. The variables k and K are constants of 1 or greater.

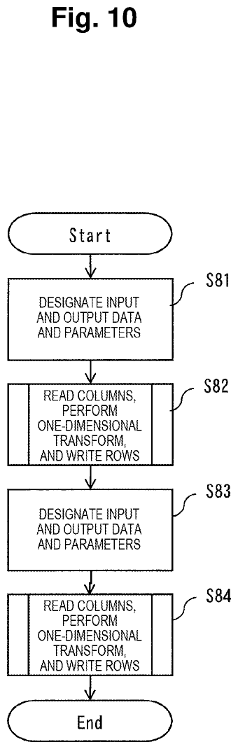

FIG. 10 is a flowchart for describing an operation of the two-dimensional data transform device of the present embodiment. The control unit 730 sets parameters to be used when the transform process execution unit 710 generates the intermediate data 102 from the original data 101 (step S81 in FIG. 10). Specifically, the control unit 730 sets the original data 101 as input data and sets the intermediate data 102 as output data. The control unit 730 sets a variable K storing the number of input data columns to the number of columns N of the original data 101 (K=N), and sets a variable S storing the number of columns to be read at one time to a predetermined value Q set by a user (S=Q).

The control unit 730 sets the number of elements of the one-dimensional data (the number of rows M of the original data 101) used by the column reading unit 712, the one-dimensional transform unit 713, and the row writing unit 714.

The control unit 730 performs switching of switches of the data switching units 741 and 742 such that the input of the column reading unit 712 (the input of the transform process execution unit 710) is the original data 101 and the output of the row writing unit 714 (the output of the transform process execution unit 710) is the intermediate data 102 according to the setting of the input data and the output data.

Although the data switching units 741 and 742 are illustrated as switches in FIG. 9, in an actual process, the data switching unit 741 sets an address of the input data read by the column reading unit 712 to be an address of the original data 101 in the auxiliary storage device 100. The data switching unit 742 sets an address of the output data to be written by the row writing unit 714 to be an address of the intermediate data 102 in the auxiliary storage device 100.

The control unit 730 and the transform process execution unit 710 read an element group of k columns in the column direction from the original data 101 before transform, perform one-dimensional transform, and write the element group after the one-dimensional transform into the auxiliary storage device 100 as an element group of k rows of the intermediate data 102 (step S82 in FIG. 10).

Specifically, the control unit 730 sets the variable k=K−i if the variable i+S>K, and sets the variable k=S if the variable i+S≤K. Subsequently, the control unit 730 instructs the column reading unit 712 to read an element group in the i-th to (i+k−1)-th columns (k columns starting from the i-th column) of the original data 101 recorded in the auxiliary storage device 100.

In response to the instruction from the control unit 730, the column reading unit 712 reads and outputs the element group in the i-th to (i+k−1)-th columns of the original data 101.

The one-dimensional transform unit 713 performs one-dimensional transform on the element group in the i-th to (i+k−1)-th columns output from the column reading unit 712, and outputs the element group.

The row writing unit 714 writes the element group after the one-dimensional transform output from the one-dimensional transform unit 713 into the auxiliary storage device 100 as an element group in the i-th to (i+k−1)-th rows (k rows starting from the i-th row) of the intermediate data 102.

The control unit 730 controls the column reading unit 712, the one-dimensional transform unit 713, and the row writing unit 714 to perform the above process on all columns (0th to (K−1)-th columns) of the input data. In an actual process, reading the element group in the i-th to (i+k−1)-th columns of the input data, performing the one-dimensional transform, and writing the element group after the one-dimensional transform as the element group of the i-th to (i+k−1)-th rows of the output data are repeated while updating the variables i and k.

The variable k is equal to the variable S except at the time of processing the last k columns (i=S·(ceil(K/S)−1)). At the time of processing the last k columns satisfying i+S>K, the variable k=K−i.

The output data (intermediate data 102) generated as described above is obtained by transposing data obtained by performing one-dimensional transform on each row of the input data (original data 101), and becomes two-dimensional data of N rows and M columns.

Next, the control unit 730 sets parameters to be used when the transform process execution unit 710 generates the final data 103 from the intermediate data 102 (step S83 in FIG. 10). Specifically, the control unit 730 sets the intermediate data 102 as input data and sets the final data 103 as output data. The control unit 730 sets the variable K storing the number of input data columns to the number of columns M of the intermediate data 102 (K=M), and sets the variable S storing the number of columns to be read at one time to a predetermined value P set by a user (S=P).

The control unit 730 sets the number of elements (the number of rows N of the intermediate data 102) of the one-dimensional data used in the column reading unit 712, the one-dimensional transform unit 713, and the row writing unit 714.

The control unit 730 performs switching of the switches of the data switching units 741 and 742 such that the input of the column reading unit 712 (the input of the transform process execution unit 710) is the intermediate data 102 and the output of the row writing unit 714 (the output of the transform process execution unit 710) is the final data 103 according to the setting of the input data and the output data.

In an actual process, the data switching unit 741 sets an address of the input data read by the column reading unit 712 to be an address of the intermediate data 102 in the auxiliary storage device 100. The data switching unit 742 sets an address of the output data to be written by the row writing unit 714 to be an address of the final data 103 in the auxiliary storage device 100.

The control unit 730 and the transform process execution unit 710 read the element group of k columns in the column direction from the intermediate data 102, perform one-dimensional transform, and write the element group after the one-dimensional transform into the auxiliary storage device 100 as elements of k rows of the final data 103 (step S84 in FIG. 10).

Specifically, the control unit 730 sets the variable k=K−i if the variable i+S>K, and sets the variable k=S if the variable i+S≤K. Subsequently, the control unit 730 instructs the column reading unit 712 to read an element group in the i-th to (i+k−1)-th columns (k columns starting from the i-th column) of the intermediate data 102 recorded in the auxiliary storage device 100.

In response to the instruction from the control unit 730, the column reading unit 712 reads and outputs the element group in the i-th to (i+k−1)-th columns of the intermediate data 102.

The one-dimensional transform unit 713 performs one-dimensional transform on the element group in the i-th to (i+k−1)-th columns output from the column reading unit 712, and outputs the element group.

The row writing unit 714 writes the element group after the one-dimensional transform output from the one-dimensional transform unit 713 into the auxiliary storage device 100 as an element group in the i-th to (i+k−1)-th rows of the final data 103 (k rows starting from the i-th row).

The control unit 730 controls the column reading unit 712, the one-dimensional transform unit 713, and the row writing unit 714 to perform the above process on all columns (0th to (K−1)-th columns) of the input data. In an actual process, reading the element group in the i-th to (i+k−1)-th columns of the input data, performing the one-dimensional transform, and writing the element group after the one-dimensional transform as the element group of the i-th to (i+k−1)-th rows of the output data are repeated while updating the variables i and k.

The variable k is equal to the variable S except at the time of processing the last k columns (i=S·(ceil(K/S)−1)). At the time of processing the last k columns satisfying i+S>K, the variable k=K−i.

The output data (final data 103) generated as described above is obtained by transposing data obtained by performing one-dimensional transform on each row of the input data (intermediate data 102), and becomes two-dimensional data of M rows and N columns.

In steps S82 and S84, the one-dimensional transform unit 713 and the row writing unit 714 do not have to receive an instruction from the control unit 730. That is, the one-dimensional transform unit 713 may perform an event-driven operation of inputting an element group of k columns, performing one-dimensional transform on, and outputting the element group, in response to output of the element group of k columns from the column reading unit 712.

Similarly, the row writing unit 714 may perform an event-driven operation of writing the element group of k columns after the one-dimensional transform as an element group (the intermediate data 102 in step S82 and the final data 103 in step S84) in the i-th to (i+k−1)-th rows of the output data into the auxiliary storage device 100, in response to output of the element group of k columns after the one-dimensional transform from the one-dimensional transform unit 713.

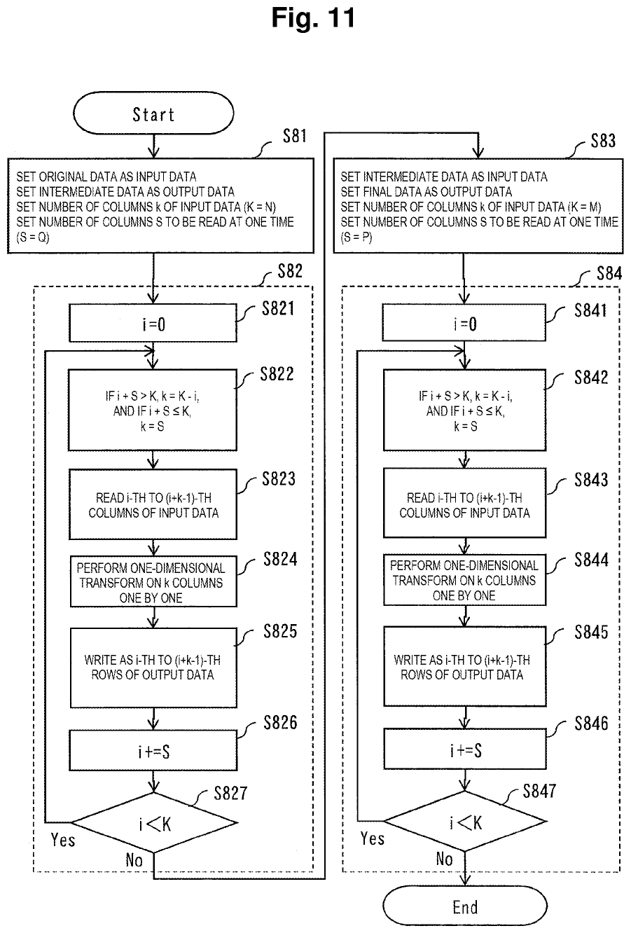

FIG. 11 is a flowchart more specifically describing the processes in steps S81 to S84 in FIG. 10. The process in step S81 of the control unit 730 is as described above.

Next, the control unit 730 initializes the variable i storing a designated column to 0 (step S821 in FIG. 11). The control unit 730 sets the variable k=K−i if the variable i+S>K, and sets the variable k=S if the variable i+S≤K (step S822 in FIG. 11).

Subsequently, the control unit 730 issues a command for reading an element group in the i-th to (i+k−1)-th columns (k columns starting from the i-th column) to the column reading unit 712. The column reading unit 712 reads and outputs the element group of the i-th to (i+k−1)-th columns of the original data 101 recorded in the auxiliary storage device 100 (step S823 in FIG. 11).

The one-dimensional transform unit 713 performs one-dimensional transform on the element group in the i-th to (i+k−1)-th columns output from the column reading unit 712 one by one and outputs the element groups (step S824 in FIG. 11).

The row writing unit 714 writes the element group after the one-dimensional transform output from the one-dimensional transform unit 713 into the auxiliary storage device 100 as an element group in the i-th to (i+k−1)-th rows (k rows starting from the i-th row) of the intermediate data 102 (step S825 in FIG. 11).

The control unit 730 increases a value of the variable i by S (step S826 in FIG. 11). If the variable i is less than K (Yes in step S827 in FIG. 11), the control unit 730 returns to step S822, and if the variable i is K or more (No in step S827), proceeds to step S822.

The above steps S821 to S827 specifically describe the process in step S82.

Next, when the variable i is equal to or more than K, the control unit 730 performs the process in step S83. The process in step S83 is as described above.

Subsequently, the control unit 730 initializes the variable i to 0 (step S841 in FIG. 11). The control unit 730 sets the variable k=K−i if the variable i+S>K, and sets the variable k=S if the variable i+S≤K (step S842 in FIG. 11).

Subsequently, the control unit 730 issues a command for reading an element group in the i-th to (i+k−1)-th columns (k columns starting from the i-th column) to the column reading unit 712. The column reading unit 712 reads and outputs the element group in the i-th to (i+k−1)-th columns of the intermediate data 102 recorded in the auxiliary storage device 100 (step S843 in FIG. 11).

The one-dimensional transform unit 713 performs one-dimensional transform on the element groups in the i-th to (i+k−1)-th columns output from the column reading unit 712 one by one and outputs the element groups (step S844 in FIG. 11).

The row writing unit 714 writes the element group after the one-dimensional transform output from the one-dimensional transform unit 713 into the auxiliary storage device 100 as an element group in the i-th to (i+k−1)-th rows (k rows starting from the i-th row) of the final data 103 (step S845 in FIG. 11).

The control unit 730 increases a value of the variable i by S (step S846 in FIG. 11). If the variable i is less than K (Yes in step S847 in FIG. 11), the control unit 730 returns to step S842, and if the variable i is K or more (No in step S847), finishes the two-dimensional transform process.

The above steps S841 to S847 specifically describe the process in step S84.

Thus, in the present embodiment, resources used for the two-dimensional transform process can be reduced compared with the first and second embodiments.

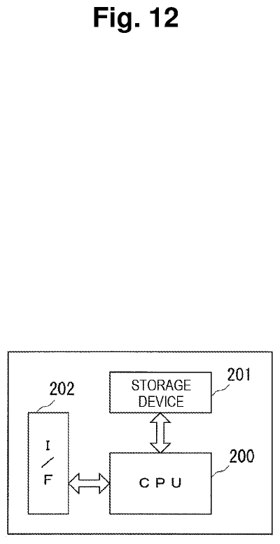

The two-dimensional data transform device described in the first to third embodiments can be implemented by a computer including a CPU, a storage device, and an interface, and a program for controlling these hardware resources. A configuration example of this computer is illustrated in FIG. 12.

The computer includes a CPU 200, a storage device 201, and an interface device (I/F) 202. The auxiliary storage device 100 and the like are connected to the I/F 202. In such a computer, a program for realizing the two-dimensional data transform method of embodiments of the present invention is stored in the storage device 201. The CPU 200 executes the processes described in the first to third embodiments according to the program stored in the storage device 201. The program may also be provided via a network.

### INDUSTRIAL APPLICABILITY

Embodiments of the present invention can be applied to a two-dimensional transform process such as two-dimensional Fourier transform or two-dimensional Hadamard transform.

### REFERENCE SIGNS LIST

100 Auxiliary storage device
110, 120, 710 Transform process execution unit
112, 122, 712 Column reading unit
113, 123, 713 One-dimensional transform unit
114, 124, 714 Row writing unit
130, 730 Control unit
741, 742 Data switching unit

1.-6. (canceled)

7. A two-dimensional data transform device, the device comprising:
a first column reader configured to read a first element group of one or more columns in a column direction of original data from an auxiliary storage device in which respective elements of the original data of M rows and N columns are continuously recorded in order in a row direction on the original data, wherein M and N are integers of 2 or greater;
a first one-dimensional transformer configured to perform one-dimensional transform on the first element group of each of the one or more columns read by the first column reader;
a first row writer configured to write the first element group of the one or more columns transformed by the first one-dimensional transformer into the auxiliary storage device as a second element group of one or more rows in the row direction of intermediate data of N rows and M columns;
a second column reader configured to read a third element group of one or more columns in the column direction of the intermediate data from the auxiliary storage device after all of the original data is transformed and recorded in the auxiliary storage device as the intermediate data;
a second one-dimensional transformer configured to perform one-dimensional transform on the third element group of each of the one or more columns read by the second column reader; and
a second row writer configured to write the third element group of the one or more columns transformed by the second one-dimensional transformer into the auxiliary storage device as a fourth element group of one or more rows in the row direction of final data of M rows and N columns;
wherein the first column reader, the first one-dimensional transformer, and the first row writer are configured to repeat processing until all of the original data is transformed and recorded in the auxiliary storage device as the intermediate data; and
the second column reader, the second one-dimensional transformer, and the second row writer are configured to repeat processing until all of the intermediate data is transformed and recorded in the auxiliary storage device as the final data.

8. A two-dimensional data transform device, the device comprising:
a column reader configured to read a first element group of one or more columns in a column direction of input data that is two-dimensional data of M rows and N columns or N rows and M columns from an auxiliary storage device, wherein M and N are integers of 2 or greater;
a one-dimensional transformer configured to perform one-dimensional transform on the first element group of each of the one or more columns read by the column reader;
a row writer configured to write the first element group of one or more columns transformed by the one-dimensional transformer into the auxiliary storage device as a second element group of one or more rows in a row direction of output data that is two-dimensional data of N rows and M columns or M rows and N columns;
a first data switcher configured to, for the auxiliary storage device in which respective elements of original data of M rows and N columns are continuously recorded in order in the row direction on the original data, perform switching of an input of the column reader such that the original data becomes the input data, and perform switching of an input of the column reader such that the intermediate data becomes the input data after all of the original data is transformed and recorded in the auxiliary storage device as the intermediate data of N rows and M columns; and
a second data switcher configured to perform switching of an output of the row writer such that the intermediate data becomes the output data and perform switching of an output of the row writer such that final data of M rows and N columns becomes the output data after all of the original data is transformed and recorded in the auxiliary storage device as the intermediate data; and
wherein the column reader, the one-dimensional transformer, and the row writer are configured to repeat processing until all of the original data is transformed and recorded in the auxiliary storage device as the intermediate data and to further repeat processing until all of the intermediate data is transformed and recorded in the auxiliary storage device as the final data.

9. A two-dimensional data transform method using the two-dimensional data transform device according to claim 8, the method comprising:
a first step of setting the original data as the input data and setting the intermediate data of N rows and M columns as the output data for the auxiliary storage device in which respective elements of the original data of M rows and N columns are continuously recorded in order in the row direction on the original data;
a second step of reading the first element group of one or more columns in the column direction of the input data from the auxiliary storage device;
a third step of performing one-dimensional transform on the first element group of each of the one or more columns read in the second step;
a fourth step of writing the first element group of the one or more columns transformed in the third step into the auxiliary storage device as the second element group of one or more rows in the row direction of the output data;
a fifth step of setting the intermediate data as the input data and setting the final data of M rows and N columns as the output data after all of the original data is transformed and recorded in the auxiliary storage device as the intermediate data;
a sixth step of reading the second element group of one or more columns in the column direction of the input data from the auxiliary storage device;
a seventh step of performing one-dimensional transform on the second element group of each of the one or more columns read in the sixth step; and
an eighth step of writing the second element group of the one or more columns transformed in the seventh step into the auxiliary storage device as a third element group of one or more rows in the row direction of the output data;
wherein in the second step, the third step, and the fourth step, processing is repeated until all of the original data is transformed and recorded in the auxiliary storage device as the intermediate data; and
wherein in the sixth step, the seventh step, and the eighth step, processing is repeated until all of the intermediate data is transformed and recorded in the auxiliary storage device as the final data.

10. A non-transitory computer readable medium for storing instructions that, when executed by a computer, cause the computer to perform the method according to claim 9.

11. A two-dimensional data transform method, the method comprising:
a first step of reading a first element group of one or more columns in a column direction of original data from an auxiliary storage device in which respective elements of the original data of M rows and N columns are continuously recorded in order in a row direction on the original data, wherein M and N are integers of 2 or greater;
a second step of performing one-dimensional transform on the first element group of each of the one or more columns read in the first step;
a third step of writing the first element group of the one or more columns transformed in the second step into the auxiliary storage device as a second element group of one or more rows in the row direction of intermediate data of N rows and M columns;
a fourth step of reading a third element group of one or more columns in the column direction of the intermediate data from the auxiliary storage device after all of the original data is transformed and recorded in the auxiliary storage device as the intermediate data;
a fifth step of performing one-dimensional transform on the third element group of each of the one or more columns read in the fourth step; and
a sixth step of writing the third element group of the one or more columns transformed in the fifth step into the auxiliary storage device as a fourth element group of one or more rows in the row direction of final data of M rows and N columns;
wherein in the first step, the second step, and the third step, processing is repeated until all of the original data is transformed and recorded in the auxiliary storage device as the intermediate data; and
wherein in the fourth step, the fifth step, and the sixth step, processing is repeated until all of the intermediate data is transformed and recorded in the auxiliary storage device as the final data.

12. A non-transitory computer readable medium for storing instructions that, when executed by a computer, cause the computer to perform the method according to claim 11.
